(19) United States
(12) Patent Application Publication
(10) Pub. No.: US 2009/0025054 A1
(43) Pub. Date: Jan. 22, 2009

(54) Method and system for access to content in a content space

(75) Inventors: Simon J. Gibbs, San Jose, CA (US); Alan Messer, Los Gatos, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/879,569

(22) Filed: Jul. 17, 2007

(51) Int. Cl. H04N 7/173

(52) U.S. Cl. 725/127

(57) ABSTRACT

A method and system for access to content is provided. Providing access to content involves constructing a smart channel that facilitates adaptive content selection, identifying known content matching the smart channel content selection, performing a smart channel query to discover new content that is related to the known content, and prefetching newly discovered relevant content from a content space. The content includes video content for display on a display such as a TV.

### FIELD OF THE INVENTION

The present invention relates to providing access to video content, and in particular to providing access to Internet video content for display.

### BACKGROUND OF THE INVENTION

The Internet is an example of video content space that is becoming a repository and distribution channel for video content. Currently, users wishing to view such content on consumer electronics (CE) devices such as televisions (TVs) encounter several obstacles because content web sites are structured for access via computer screens such as the personal computer (PC). Without a pointing device and keyboard, web sites are difficult to navigate on consumer electronics devices such as TVs. Further, the layout (font size, etc.) of a web site may not be appropriate for TVs.

In addition, accessing content on such web sites typically involves a delay (at least a few seconds) as content is downloaded and buffered before viewing starts. This presents TV users with either blank screens or download progress bars when users switch between content selections for viewing. In addition, currently much of the Internet video content is in short form (a few minutes in length). Such short form would require TV users to continually make new content selections every few seconds/minutes.

Some web sites provide personalized aggregation of Internet content. More recently, some web sites provide video content dynamically constructed based on content from other web sites. Content is aggregated using predefined queries specified by the user or a site developer. However, there is no option to tune to content related to a particular user's changing interests. Furthermore, when content items from the aggregation are “played” via a browser, each content item is sequentially accessed when the previous one finishes, and downloaded while the user waits. There is no smooth transition from one content item to another.

### BRIEF SUMMARY OF THE INVENTION

The present invention provides a method and system for access to content. In one embodiment, providing access to content includes constructing a smart channel that facilitates adaptive content selection, identifying known content matching the smart channel content selection, performing a smart channel query to discover new content that is related to the known content, and prefetching newly discovered relevant content from a content space.

In one implementation, the content includes video content and the content space can be the Internet. Constructing smart channels facilitates access to relevant content such as video in a manner that is suitable for access such as viewing on devices such as TV displays. A smart channel provides content selection that changes based on content space changes, user context changes and/or user preference changes. The smart channel content selection can also change based on user specified criteria. As such, a smart channel facilitates adaptive content selection based on one or more factors such as: content space change, user context change, user specified criteria, etc.

A content access system constructs smart channels which enable access to Internet video content on a TV, without requiring direct user interaction with Internet video web sites for content selection. The content access system also reduces delays in viewing selected content by prefetching the smart channel content selection.

These and other features, aspects and advantages of the present invention will become understood with reference to the following description, appended claims and accompanying figures.

### BRIEF DESCRIPTION OF THE DRAWINGS

FIG. 1 shows a functional block diagram of a local area network including electronic devices, implementing an embodiment of the present invention.

FIG. 2 shows the steps of a process for content access using smart channels, according to an embodiment of the present invention.

FIG. 3 shows a functional block diagram of a content access system for user defined smart channels with intelligent prefetch, according to an embodiment of the present invention.

FIG. 4 shows a functional block diagram of a content access system for adaptive smart channels with intelligent prefetch, according to an embodiment of the present invention.

FIG. 5 shows a functional block diagram of another local area network including electronic devices, implementing an embodiment of the present invention.

### DETAILED DESCRIPTION OF THE INVENTION

The present invention provides a method and system for access to content in content space, such as the Internet, by constructing smart channels that facilitate access to relevant content such as video in a manner that is suitable for access such as viewing on devices such as TV displays.

The term “channel” as used herein refers to a content selection that is presented to the user. A smart channel is adaptive based on such factors as changes in the content space or changes in the user context (e.g., what is currently being viewed on a TV, location of the user, user-media interactions via media players) and/or user related information such as patterns in user behavior, history of user actions in accessing content, user profile, etc.

In one embodiment, the present invention provides a content access system that implements smart channels for enabling access to Internet video content from content web sites and display on a TV, without requiring a user to interact directly with such content web sites.

In one example, a smart channel facilitates adaptive content selection based on one or more of: content space change, user context change and user specified criteria. The content access system also reduces delays in viewing selected content by prefetching content ahead of viewing.

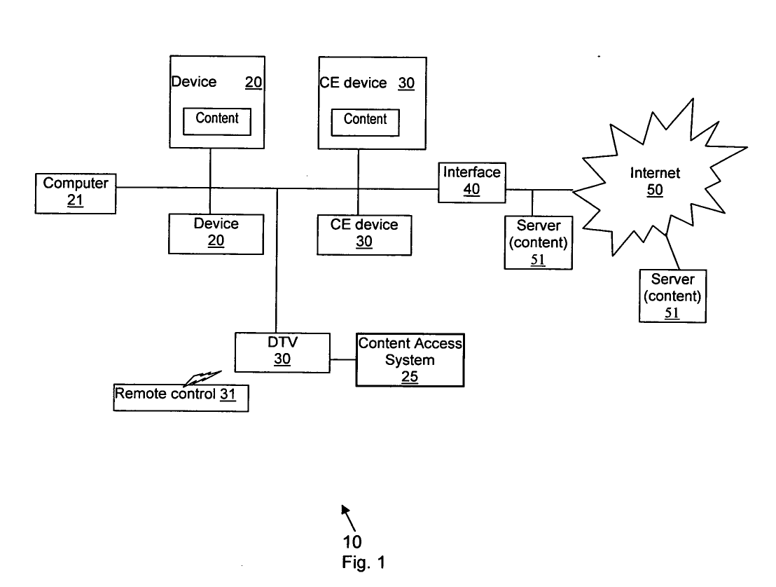

FIG. 1 shows a functional architecture of an example network, such as a local area network (LAN) 10 in a home environment, embodying aspects of the present invention. The network 10 comprises electronic devices 20 (e.g., appliances, databases, storage devices) which may include local content, a PC 21, CE devices 30 (e.g., TV, DTV, PDA, media player) which may include local content, and an interface 40 that connects the network 10 to an external network 50 (e.g., data sources, the Internet). The network 10 may also be connected to one or more servers 51, as shown.

Though the example described hereinbelow relates to the CE devices 30, the present invention is equally applicable to other devices. One or more devices 30 can implement the Universal Plug and Play (UPnP) protocol for communication therebetween. The present invention is useful with other network communication protocols (e.g., Jini, HAVi, IEEE 1394). Further the network 10 can be a wireless network (e.g., IEEE 802.11), a wired network (e.g., Ethernet, IEEE 1394), or a combination thereof.

The network 10 further provides a content access system 25 that constructs smart channels including content selection based on patterns in user behavior and/or user defined preferences. The former allows the smart channel to adapt to changes in usage and user context.

The content space includes both local content (e.g., content available on the user's devices or home network) and Internet content (on network servers or remote devices). Both local content and Internet content from the content space may appear in the smart channel content selection. The content access system pre-fetches video items in the smart channel content selection to assure better continuity when viewed.

In one implementation, a smart channel content selection represents a query that selects video content from a set of video items (e.g., in the content space). Example queries include: videos about “extreme golf”, episodes of “Lost in Space”, movies of genre “SF”, release dates after 2000, popular sitcom episodes, etc. Query syntax depends on implementation; an example can be SQL with a free text search/matching.

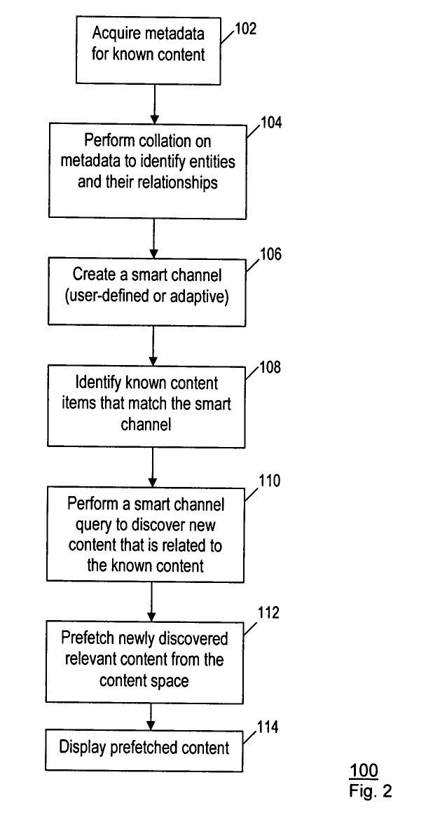

Content may be “known” (i.e., it has been identified and metadata associated with it is available locally) or “unknown” (i.e., content which has not been encountered or identified). The metadata associated with known content includes attributes and values (e.g., Title: Spiderman, Genre: action), and it may be hierarchically structured (e.g., XML). FIG. 2 shows the steps of an example process 100 for access to known/unknown content using smart channels according to the present invention, including the following steps:

Step 102: Acquire metadata for known content.

Step 104: Perform collation on metadata (e.g., ordering of metadata categories) to identify entities therein, and their relationships.

Step 106: Create a smart channel from said identified entities and their relationships, based on user selected criteria or usage data representing user behavior. The smart channel includes content selection from said identified entities and their relationships.

Step 108: Identify known content items that match the smart channel content selection.

Step 110: Perform a smart channel query to discover new content in the content space that is relevant to the known content.

Step 112: Prefetch newly discovered relevant content from the content space.

Step 114: Display prefetched content on a TV.

An implementation of each of the above steps is now described. In step 102 above, metadata for known content is acquired by “crawling” devices on the home network and importing metadata from known applications (e.g., WMP, iTunes), and from known web sites. The resulting metadata is stored locally in a database on the home network.

The database may also contain commercial metadata collections encompassing large numbers of titles (e.g., major motion pictures). The structure of the database is governed by a schema which resembles the attributes found in the metadata.

In step 104 above, once metadata is imported, it goes through a collation procedure that attempts to identify entities in that metadata, and identify relationships between those entities. Different collation techniques can be used. The result of collation is a set of content graphs which resemble structures that link content items based on similarities (e.g., same genre, same actor).

In step 106 above, a smart channel can be created based on user defined criteria including certain selection criteria (e.g., topics, keywords), based on which the content selection in the smart channel is defined. The smart channel can alternatively be adaptive based on usage data. The usage data is a function of user behavior and in one example, comprises a time-stamped log identifying which content item was viewed at which time.

A data mining process is applied to the log to extract path models that identify common viewing patterns. An example path model can be “Saturday evening/family”. The path model and the current user context define a smart channel that changes as the context changes.

In step 108 above, the smart channel is provided to a contextual recommender that identifies a set of known content items (i.e., context content graph) that match the smart channel. A recommendation algorithm determines a similarity measure between content items. Various similarity functions can be used. In one example, since each content item has a set of attributes, for each attribute an importance weight is assigned, an item-item similarity is assigned as the weighted sum of the similarities of each attribute, and attribute-attribute similarity is calculated using a string similarity function.

In step 110 above, the context content graph is then expanded into a relevant content graph. This involves executing a smart channel query over Internet content (the query may be modified from the form used for local content), and discovering new content items that are related to the known content. The relevant content graph identifies the discovered content items, and is essentially the materialized form of the smart channel (i.e., the result of evaluating the query associated with the smart channel).

In step 112 above, the content items identified by the relevant content graph are prefetched from the content space. This may involve simply stepping through a content item list and downloading each content item. Other, more elaborate methods can be used where the order of prefetching (the “prefetch plan”) is determined by relevancy. For adaptive smart channels, the prefetch plan changes as the context changes. Prefetching enables smooth transitions between content items when later viewed on a TV.

In step 114 above, the perfected content is displayed on a TV per user request such as via a remote control 31 for a TV (FIG. 1).

The above content access process and smart channel construction can be implemented, e.g., as a content access system in a TV with access to the Internet, or in a suitable device connected to the TV. Such a suitable device has access to the internet and can place video on a TV. Examples of such a suitable device include a personal video recorder (PVR), a set-top box (STB), a PC with a media extender, etc.

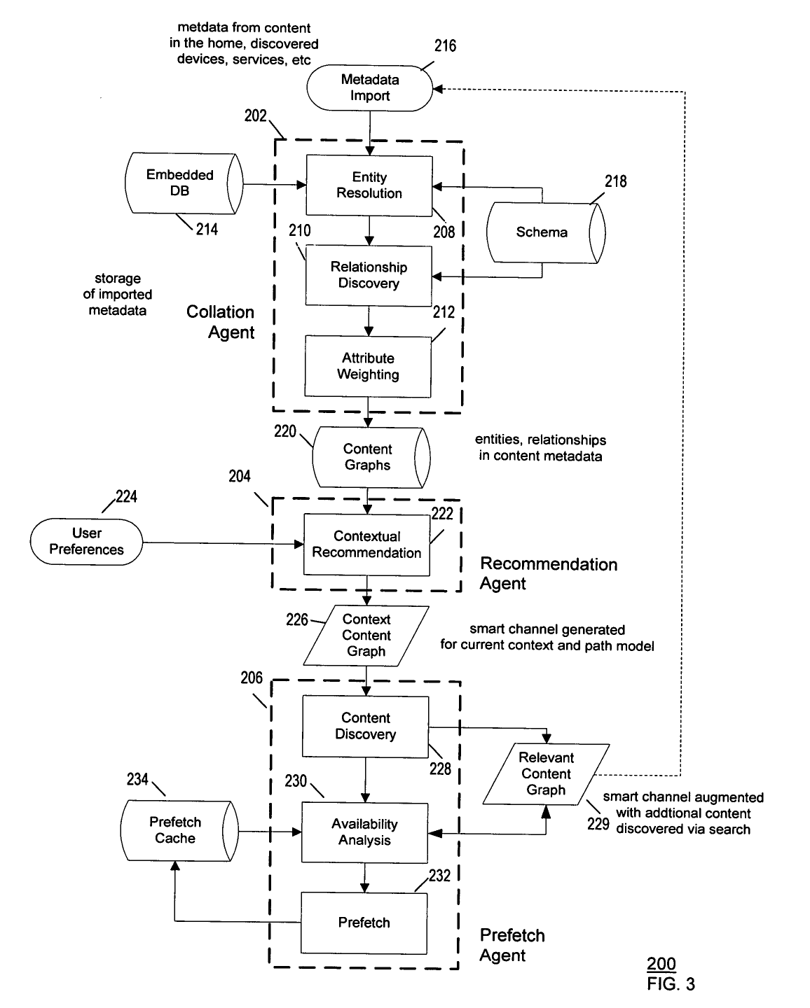

FIG. 3 shows a functional block diagram of a content access system 200 implementing user defined smart channels with intelligent prefetch, according to an embodiment of the present invention. The content access system 200 includes a Collation Agent module 202, a Recommendation Agent module 204 and a Prefetch Agent module 206, described below.

The Collation Agent module 202 includes an Entity Resolution module 208, a Relationship Discovery module 210 and an Attribute Weighting module 212. An Embedded DB (database) component 214 provides a database of video metadata (e.g., title, episode, genre, date, synopsis/description, list of actor's names, broadcast time and channel, keywords (possibly obtained from closed captioning)).

A Metadata Import component 216 inserts new metadata into the Embedded DB component 214. The structure of the Embedded DB component 214 is governed by a Schema 218 which resembles the attributes found in the metadata. The schema 218 provides a description of the Embedded DB database, and in particular identifies entities, attributes and relationships therebetween. The Metadata Import component 216 can reside on the content access system such as on a TV, PVR or STB.

Using the Schema 218, the Entity Resolution module 208 identifies entities (e.g., actor information, show names) in the Embedded DB component 214. Also using the Schema 218, the Relationship Discovery module 210 identifies the relationships (e.g., appears-in) between the identified entities in the Embedded DB component 214.

The Attribute Weighting module 212 then assigns an accuracy score (e.g., between 0 for unknown and 1 for certain) to attributes of entities in the Embedded DB component 214, and generates Content Graphs 220. A Content Graph links content to other content via relationships (e.g., Show X is linked to Show Y because they have a common actor or the same title). In one example, a Content Graph comprises a graph structure including nodes representing content items, and relationship links between the content nodes.

The Content Graphs 220 is processed by a Contextual Recommendation module 222 in the Recommendation Agent module 204. The Contextual Recommendation module 222 recommends (selects) a set of content items using the information in the Content Graphs 220 and current User Preferences 224. The User Preferences 224 indicates viewing preferences specified by a user. For example, a weighted set of attributes (such as genre), a list of “favorites”, a list of topics of interest, etc.

The Contextual Recommendation module 222 prunes non-recommended content nodes from the Content Graphs 220, resulting in the Context Content Graph 226. The Context Content Graph 226 comprises a sub-graph of content nodes from the Content Graphs 220, rooted at the content that is currently in context (e.g., being viewed or otherwise selected). Content nodes may also have additional information, such as an ordering to indicate a playout or a next/previous sequence.

The Context Content Graph 226, then, includes a set of content nodes with a type of order attribute (e.g., a “search results” list that a search engine produces). Each node may have some additional information such as relevancy measure, original metadata, etc. In addition, the links structure may be retained since each content node that appears in a Content Graph has one or more links to other content nodes.

The Context Content Graph 226 is provided to the Prefetch Agent module 206. The Prefetch Agent module 206 includes a Content Discovery module 228, an Availability Analysis module 230 and a Prefetch module 232, as described below. The Content Discovery module 228 performs an Internet search for discovering content related to content identified in the Context Content Graph 226. The query terms for the corresponding smart channel are searched on one or more Internet sites, and any discovered content is added to this graph, forming a Relevant Content Graph 229.

As such, the Relevant Content Graph 229 comprises a Context Content Graph 226 that has been augmented with additional nodes and links (relationships) corresponding to the content discovered via the Internet search. The Relevant Content Graph has the same format as the Context Content Graph, wherein nodes now may refer to content not on the device implementing the content access.

Specifically, the smart channel query terms are translated into a form appropriate for the web site being used to execute the search. The resulting query is issued to the web site, and the results are parsed and added to the Context Content Graph to form the Relevant Content Graph. Items/nodes appearing in the Relevant Content Graph refer to Internet content, which typically have a title, description, URL, MIME type and perhaps the file size.

The Availability Analysis module 230 determines if content items appearing in the Relevant Content Graph 229 should be downloaded (prefetched). If so, such content items are added to a prefetch list. The Prefetch module 232 then downloads content items on the prefetch list. A Prefetch Cache 234 maintains segments of content (e.g., video files) that have been downloaded and stored, for user viewing.

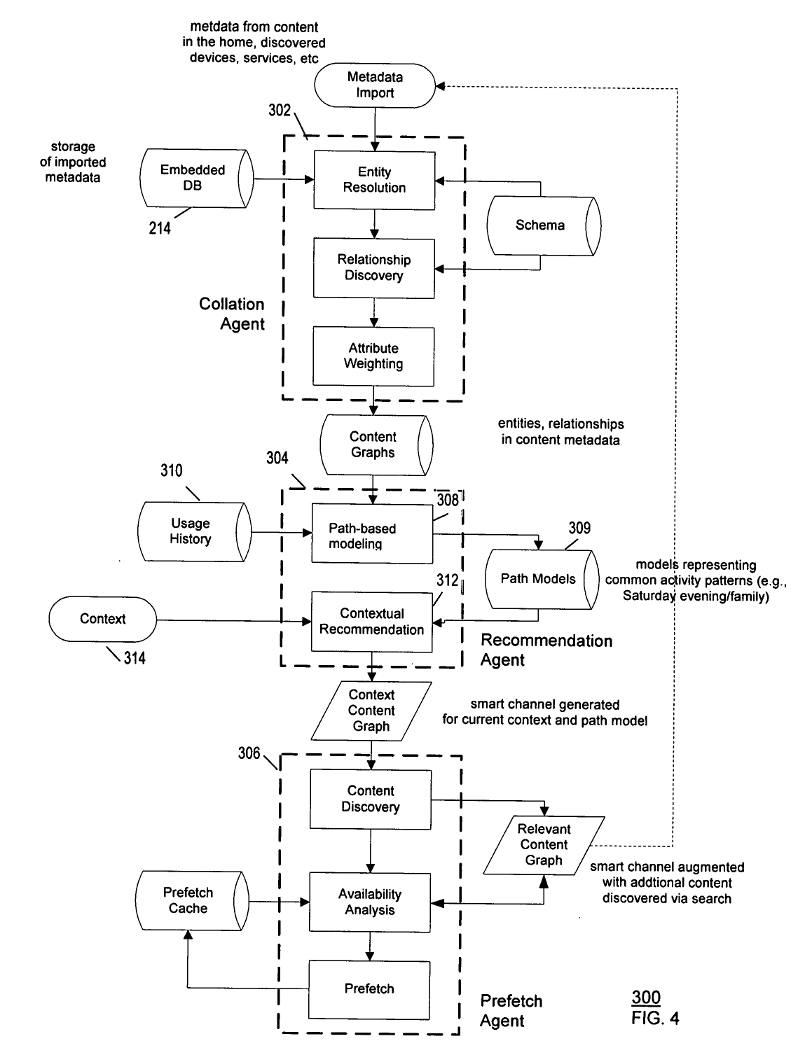

FIG. 4 shows a functional block diagram of a content access system 300 implementing adaptive smart channels with intelligent prefetch, according to an embodiment of the present invention. The content access system 300 includes a Collation Agent module 302, a Recommendation Agent module 304 and a Prefetch Agent module 306. The Collation Agent module 302 operates in a similar fashion as the Collation Agent module 202 in FIG. 3 for generating Content Graphs, and is not described further.

The Recommendation Agent module 304 prunes non-recommended content from the Content Graphs, resulting in the Context Content Graph for the Prefetch Agent module 306. Specifically, the Recommendation Agent module 304 includes a Path-based Modeling module 308 that constructs Path Models 309 from a Usage History 310. A Path Model comprises a model of viewing behavior extracted from the Usage History (e.g., Bayesian networks representing viewing behavior).

The Usage History 310 comprises a log of viewing activity, indicating, e.g., what was watched and when. The creation of the Path Models is based on data mining algorithms to find common patterns in a viewing log (e.g., Path Model: “Saturday morning, these are the most commonly viewed shows: x, y, z, and if one is viewing x, then with probability 0.3, y is viewed after it”).

The Recommendation Agent module 304 also includes a Contextual Recommendation module 312 that identifies a set of recommended content using a Context 314, the current Path Model and the information in the Content Graphs generated by the Collation Agent module 302.

The Context 314 provides a representation of the current context, which may include a current path model, a current show, previous n shows, how long was spent on each show, a measure of channel surfing (e.g., channel changes per second over 10 seconds, 30 seconds, one minute), metadata for a current show, etc. The context identifies the path model that is “active”, that fits the current situation. The path model identifies types of content (e.g., program names, genre, topics, etc.) that appear relevant.

This relevancy information is used to form the query for the smart channel. Query terms from the smart channel are then used in identifying known content in the content space. A query specified by a smart channel is evaluated (executed as search in the content space) to generate a Context Content Graph which can be traversed to generate a linear sequence for content items.

The Prefetch agent module 306 then operates on the Context Content Graph in a similar fashion as the Prefetch agent module 206 in FIG. 3. A Prefetch Cache maintains segments of content (e.g., video files) that have been downloaded and stored, for user viewing on the TV. When context changes, entries in an adaptive smart channel (a “micro-channel” constructed from context rather than a user's preferences) that are no longer relevant, are removed from the prefetch list.

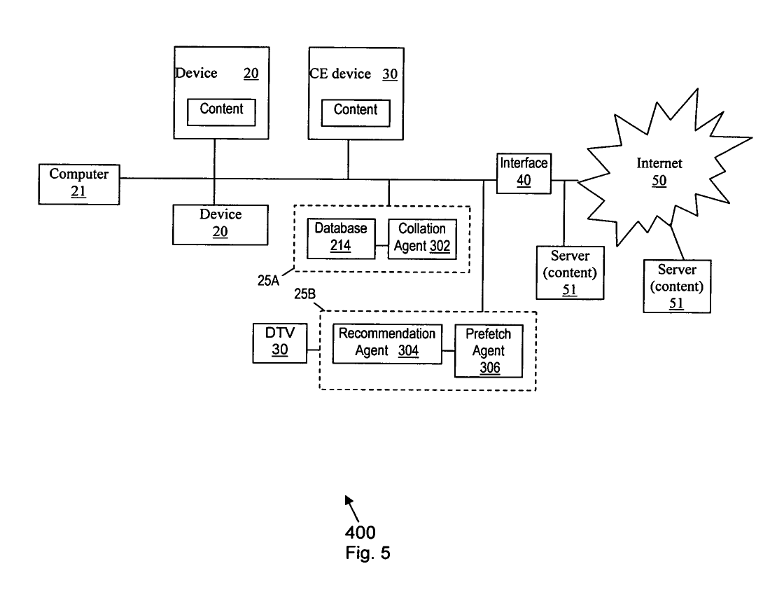

FIG. 5 shows a functional block diagram of a local area network 400 according to an embodiment of the present invention. The network 400 is a variation of the network 10 in FIG. 1, implementing the content access system of FIG. 4. In FIG. 5, the Recommendation Agent 304 and the Prefetch Agent 306 are implemented as a module 25B that is connected to the DTV 30, and the database 214 and Collation Agent 302 are implemented as a module 25A.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method for access to content, comprising the steps of:
constructing a smart channel that facilitates adaptive content selection;
identifying known content matching the smart channel content selection;
performing a smart channel query to discover new content that is related to the known content; and
prefetching newly discovered relevant content from a content space.

2. The method of claim 1 wherein constructing a smart channel further includes creating a smart channel that facilitates adaptive content selection based on one or more of: content space change, user context change and user specified criteria.

3. The method of claim 2 further including the steps of:
acquiring metadata for known content; and
performing collation on the metadata to identify entities and their relationships.

4. The method of claim 3 wherein constructing a smart channel further includes creating a smart channel that includes content selection from the identified entities and their relationships, based on one or more of: content space change, user context change and user specified criteria.

5. The method of claim 4 wherein performing collation on the metadata includes performing entity resolution to identify entities in the metadata.

6. The method of claim 5 wherein performing collation further includes performing relationship discovery to identify relationships between the identified entities.

7. The method of claim 6 wherein performing collation further includes performing attribute weighting on accuracy of entity attributes for linking different content via relationships.

8. The method of claim 3 wherein constructing a smart channel further includes:
selecting content based on the identified entities and their relationships, wherein the selected content represents the smart channel content selection.

9. The method of claim 8 wherein constructing a smart channel further includes:
selecting content based on the identified entities and their relationships, wherein the selection is rooted at the content that is currently in context.

10. The method of claim 9 wherein performing a smart channel query further includes searching the content space for discovering content related to the selected content.

11. The method of claim 10 wherein searching the content space includes searching the content space using queries terms based on a corresponding smart channel.

12. The method of claim 11 wherein searching further includes translating the query terms into a form appropriate for Internet searching.

13. The method of claim 11 further including the steps of obtaining search results and based on the search results determining which selected content items are available for prefetching.

14. The method of claim 13 wherein prefetching further includes prefetching available content items from the content space.

15. The method of claim 14 wherein prefetching further includes caching prefetched content items for access.

16. The method of claim 1 wherein content items include audio/visual content items for display on a TV.

17. The method of claim 1 wherein constructing a smart channel further includes creating a smart channel that includes content selection based on user preferences.

18. The method of claim 1 wherein constructing a smart channel further includes creating a smart channel that includes content selection based on user context.

19. The method of claim 1 wherein constructing a smart channel further includes creating a smart channel that includes content selection based on user related information.

20. The method of claim 1 wherein constructing a smart channel further includes creating a smart channel that includes content selection based on content space.

21. The method of claim 1 wherein constructing a smart channel further includes creating a smart channel that includes content selection based on changes in one or more of: user preferences, user context, user related information, content space.

22. An apparatus for access to content, comprising:
a constructor configured for constructing a smart channel that facilitates adaptive content selection, and identifying known content matching the smart channel;
a discovery module configured for performing a smart channel query to discover new content that is related to the known content; and
a prefetch module configured for prefetching newly discovered relevant content from a content space.

23. The apparatus of claim 22 wherein the constructor is further configured for constructing a smart channel that facilitates adaptive content selection based on one or more of: content space change, user context change and user specified criteria.

24. The apparatus of claim 23 further comprising:
a metadata acquisition module configured for acquiring metadata for known content; and
a collation module configured for performing collation on the metadata to identify entities and their relationships.

25. The apparatus of claim 24 wherein the constructor further includes a contextual constructor that is configured for creating a smart channel that includes content selection from the identified entities and their relationships, based on one or more of: content space change, user context change and user specified criteria.

26. The apparatus of claim 25 wherein the collation module includes a resolution module configured for performing entity resolution to identify entities in the metadata.

27. The apparatus of claim 26 wherein the collation module further includes a discoverer configured for performing relationship discovery to identify relationships between the identified entities.

28. The apparatus of claim 27 wherein the collation module further includes a weighting module configured for performing attribute weighting on accuracy of entity attributes for linking different content via relationships.

29. The apparatus of claim 24 wherein the constructor is further configured for selecting content based on the identified entities and their relationships, wherein the selected content represents the smart channel content selection.

30. The apparatus of claim 29 wherein the constructor is further configured for selecting content based on the identified entities and their relationships, wherein the selection is rooted at the content that is currently in context.

31. The apparatus of claim 30 wherein the discovery module is further configured for performing a smart channel query by searching the content space for discovering content related to the selected content.

32. The apparatus of claim 31 wherein the discovery module is further configured for searching the content space using queries terms based on a corresponding smart channel.

33. The apparatus of claim 32 further including an availability module configured for determining which selected content items are available for prefetching based on the search results.

34. The apparatus of claim 33 wherein the prefetching module is further configured for prefetching available content items from the content space.

35. The apparatus of claim 34 further including a cache such that the prefetching module is further configured for caching prefetched content items for later access.

36. The apparatus of claim 22 wherein content items include audio/visual content items for display on a TV.

37. The apparatus of claim 22 wherein the constructor is further configured for constructing a smart channel further includes creating a smart channel that includes content selection based on user preferences.

38. The apparatus of claim 22 wherein the constructor is further configured for creating a smart channel that includes content selection based on user context.

39. The apparatus of claim 22 wherein the constructor is further configured for creating a smart channel that includes content selection based on user related information.

40. The apparatus of claim 22 wherein the constructor is further configured for creating a smart channel that includes content selection based on content space.

41. The apparatus of claim 22 wherein the constructor is further configured for creating a smart channel that includes content selection based on changes in one or more of: user preferences, user context, user related information, content space.
